(19) United States
(12) Patent Application Publication
(10) Pub. No.: US 2007/0061538 A1
(43) Pub. Date: Mar. 15, 2007

(54) Programming method of non-volatile memory device having multi-plane structure

(75) Inventors: Seung Ho Chang, Chungcheongbuk-do (KR); Joong Seob Yang, Kyeongki-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hynix Semiconductor Inc., Kyoung-do (KR)

(21) Appl. No.: 11/322,844

(22) Filed: Dec. 29, 2005

(30) Foreign Application Priority Data
Sep. 15, 2005 (KR) 2005-86179

(51) Int. Cl. G06F 13/28; G06F 12/00

(52) U.S. Cl. 711/169; 711/103

(57) ABSTRACT

A method for performing a program operation of a non-volatile memory device includes loading first, second, third, and fourth data to first, second, third, and fourth page buffers, respectively, in sequence; programming the first data loaded onto the first page buffer into a first page while loading the second data to the second buffer; and programming the second data loaded onto the second page buffer into a second page while programming the first data into the first page.

### CROSS-REFERENCES TO RELATED APPLICATIONS

The present application claims priority to Korean Patent Application No. 10-2005-86179, filed Sep. 15, 2005 and is incorporated by reference.

### BACKGROUND OF THE INVENTION

The present invention relates to a program method of non-volatile memory devices, and more particularly, to a program method of NAND flash memory devices having a multi-plane structure.

A NAND flash memory device has a low program speed, i.e., several hundreds of μs. Therefore, increasing program speed becomes an important parameter in enhancing the performance of a chip. To increase program speed, a variety of program operation methods such as “cache program” and “multi-page program” have been proposed.

FIG. 1 illustrates an existing NAND flash memory device with a multi-plane structure using the multi-page program method.

Referring to FIG. 1, the multi-page program method includes sequentially loading data onto a page buffer (not shown) on each of the planes (e.g., four planes) (\textcircled{1} is data loading onto a page buffer of the first plane, \textcircled{2} is data loading onto a page buffer of the second plane, \textcircled{3} is data loading onto a page buffer of the third plane and \textcircled{4} is data loading onto a page buffer of the fourth plane), and programming four pages at the same time by programming the data loaded onto each page buffer within the entire planes (\textcircled{5} is a program time). After these four pages are programmed, next four pages (i.e., pages 5-8) are programmed using the same procedure.

For example, assuming that one page buffer is 2 Kbyte, the time in which data are loaded onto one page buffer is 25 ns and the program time of one page is 150 us in a NAND flash memory device having a 4-plane structure, the time in which eight pages are consecutively programmed is 50 us+50 us+50 us+50 us+150 us+50 us+50 us+50 us+50 us+150 us=700 us where 50 us=2 K×25 ns. That is, after four pages are loaded consecutively, they are programmed at the same time, then the next four pages are loaded consecutively and programmed again at the same time.

The multi-page program method reduces the program performance if pages are consecutively programmed.

FIG. 2 is a view illustrating a cache program method of a NAND flash memory device using the existing cache latch.

Referring to FIG. 2, the cache program method is a method of programming one page by burying the data loading time (\textcircled{1} is a time where data are loaded onto a cache latch and (\textcircled{1}′ is a time where data are loaded from a cache latch to a main latch (not shown)) into a programming time (\textcircled{2}) within a single plane.

For example, assuming that one page buffer is 2 Kbyte, the time in which data are loaded onto one page buffer is 25 ns and the program time of one page is 150 us in a NAND flash memory device having a cache latch, the time in which eight pages are consecutively programmed at once is 50 us+(150 us×8)=1250 us where 50 us=2 K×25 ns. That is, one page is programmed at a time.

The cache program method is advantageous in tat the number of cells that are programmed at once does not exceed one page since an additional cache latch is required and is consecutively operated within one plane.

FIG. 3 is a view illustrating a program method of a general NAND flash memory.

Referring to FIG. 3, the general program method is a method of programming one page at a time where data are loaded onto a page buffer (not shown) within a single plane (\textcircled{1}) and then the loaded data is programmed (\textcircled{2}).

For example, assuming that one page buffer is 2 Kbyte, the time in which data are loaded onto one page buffer is 25 ns and the program time of one page is 150 us in a general NAND flash memory device, the time where eight pages are consecutively programmed is (50 us+150 us)×8=1600 us where 50 us=2 K×25 ns. That is, one page is programmed at a time.

In the general NAND flash memory device, both a data input time and a data program time are needed when programming one page. Therefore, the conventional program method requires a significantly longer program time than a multi-page program or a cache program method.

### BRIEF SUMMARY OF THE INVENTION

An advantage of the present invention is that it provides a program method for a NAND flash device having a multi-plane structure, in which data are programmed while other data are being loaded, thus reducing the program time.

According to an aspect of the present invention, there is provided a program method for a non-volatile memory device having at least two or more planes, wherein if data loading onto page buffers of a plane that is firstly selected is finished while the data are sequentially loaded onto each of the page buffers of the entire plane, the data that have been loaded onto the page buffers of the first plane are programmed until data that have been loaded onto page buffers of a plane that is sequentially lastly selected are programmed.

According to another aspect of the present invention, there is provided a program method of a non-volatile memory device having N (N is a natural number) planes, wherein if data loading onto page buffers of a plane that is firstly selected is finished while the data are sequentially loaded onto each of the page buffers of some selected planes of the N planes, the data that have been loaded onto the page buffers of the first plane are programmed until data that have been loaded onto page buffers of a plane that is sequentially lastly selected are programmed.

In one embodiment of the present invention, a program method for a non-volatile memory device includes storing first data to a first page buffer of a first plane of the memory device; programming the first data stored in the first page buffer to a first page of the first plane; storing second data to a second page buffer of a second plane of the memory device while the first data are being programmed into the first page of the first plane; and programming the second data stored in the second page buffer to a second page of the second plane while the first data are being programmed into the first page of the first plane. The method further includes storing third data to a third page buffer of a third plane of the memory device while the second data are being programmed into the second page of the second plane; and programming the third data stored in the third page buffer to a third page of the third plane while the second data are being programmed into the second page of the second plane.

In another embodiment, a method for performing a program operation of a non-volatile memory device includes loading first, second, third, and fourth data to first, second, third, and fourth page buffers, respectively, in sequence; programming the first data loaded onto the first page buffer into a first page while loading the second data to the second buffer; and programming the second data loaded onto the second page buffer into a second page while programming the first data into the first page. The program operation involves N number of pages and is completed by (N×Ts)+Tp, wherein Ts relates to a time period required to load given data to a given page buffer, wherein Tp relates to the a time period required to program the given data stored in the given page buffer into a given page, wherein a time period Ts of each of the first, second, third, and fourth data is substantially the same, and a time period Tp for each of the first, second, third, and fourth data is substantially the same.

### BRIEF DESCRIPTION OF THE DRAWINGS

FIG. 1 is a view illustrating a multi-page program method of a NAND flash memory device using existing multi-plane structure;

FIG. 2 is a view illustrating a cache program method of an NAND flash memory device using existing cache latch;

FIG. 3 is a view illustrating a program method of a conventional NAND flash memory; and

FIGS. 4 to 6 are views illustrating a multi-page program method of an NAND flash memory device having a multi-plane structure according to an embodiment of the present invention.

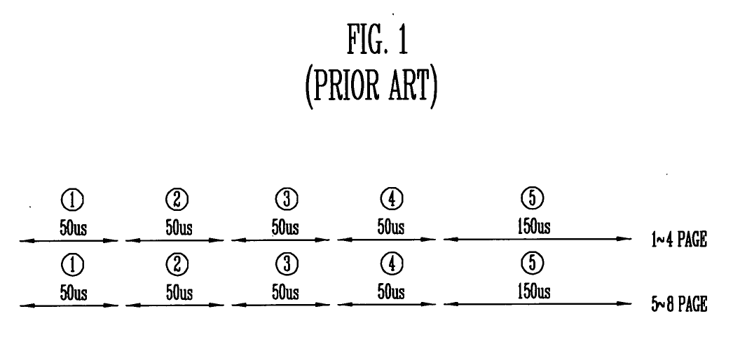

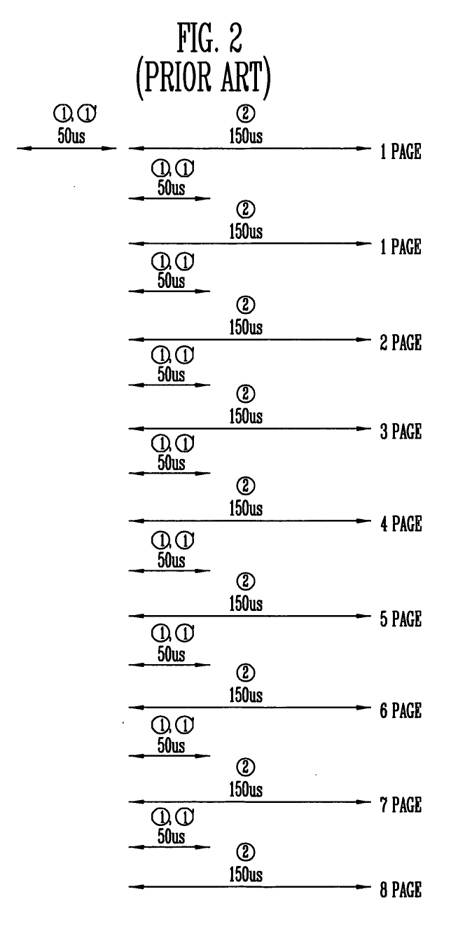

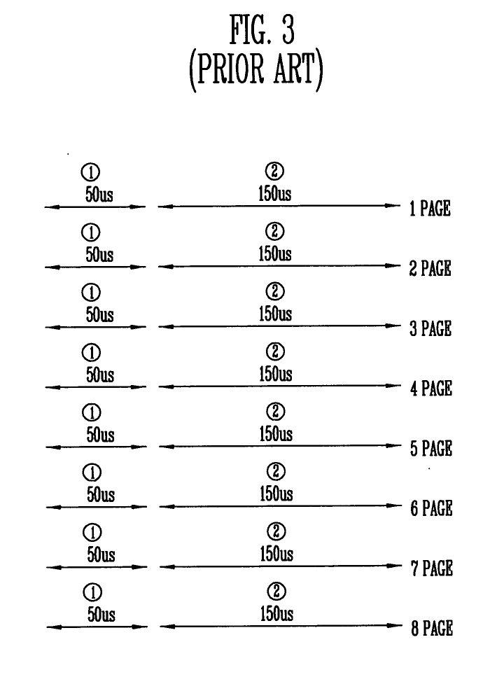

### DETAILED DESCRIPTION OF THE INVENTION

The present invention will now be described in connection with specific embodiments with reference to the accompanying drawings.

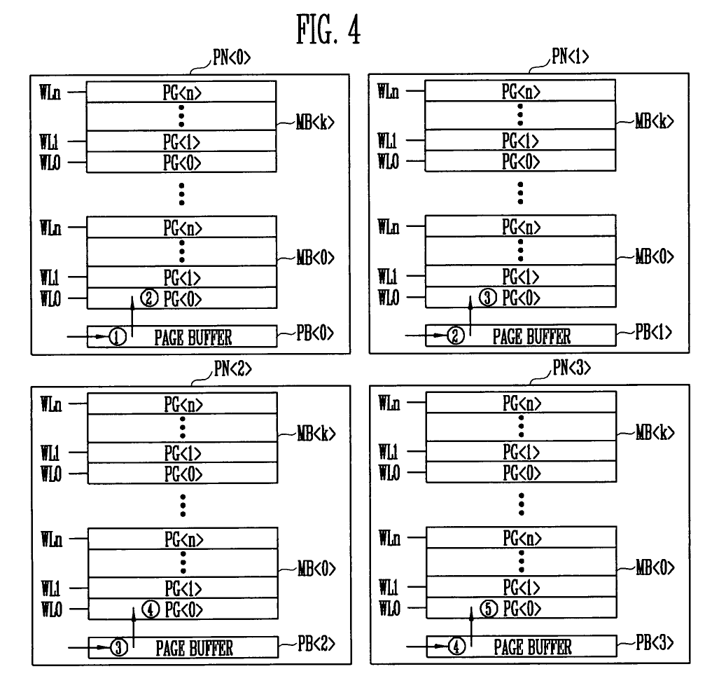

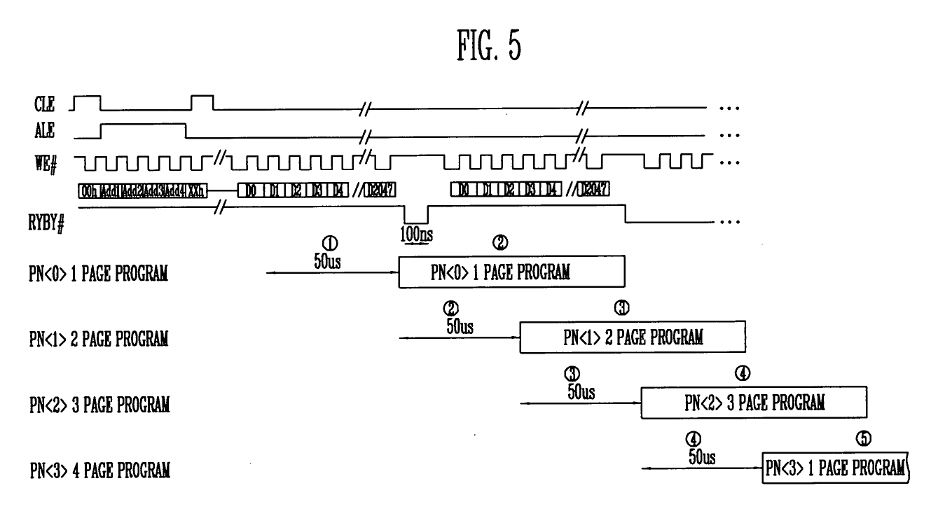

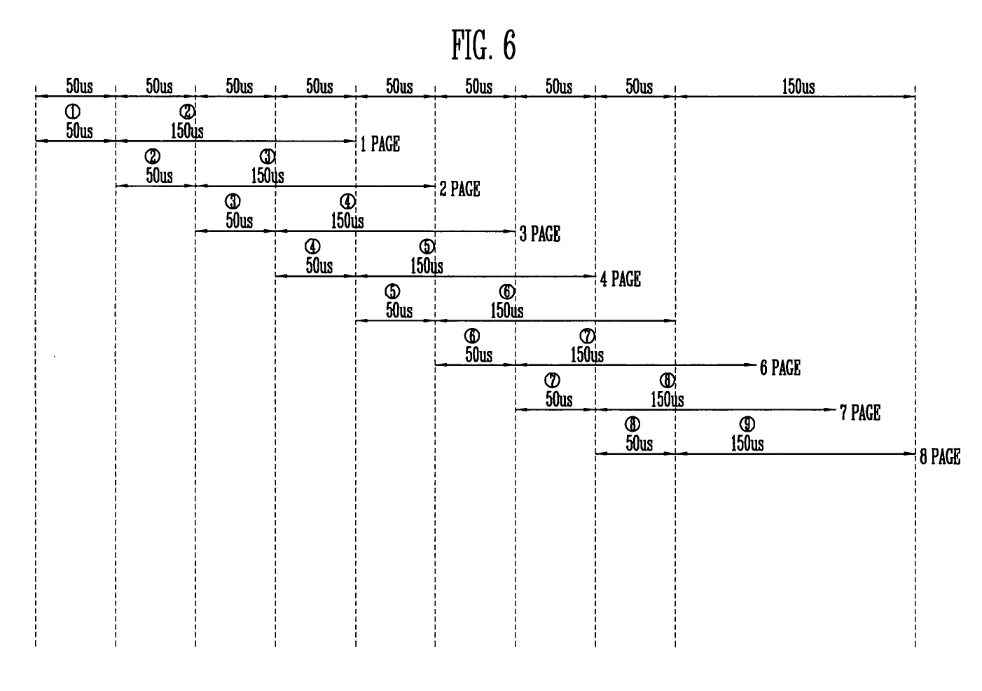

FIGS. 4 to 6 are views illustrating a multi-page program method of a NAND flash memory device having a multi-plane structure according to an embodiment of the present invention. FIG. 4 is a block diagram of the multi-page program method of the NAND flash memory device having the multi-plane structure. FIG. 5 is a timing diagram of a four-page program method of the NAND flash memory device having the 4-plane structure shown in FIG. 4. FIG. 6 is a timing diagram of an eight-page program method of the NAND flash memory device having the 4-plane structure shown in FIG. 4.

Referring to FIG. 4, the NAND flash memory device including the multi-plane structure includes four planes PN<0> through PN<3>. Although four planes are shown in FIG. 4, the number of planes may vary according to applications. Each of the planes PN<0> through PN<3> includes k memory cell blocks MB<0> through MB<k>. Each of the memory cell blocks MB<0> through MB<k> includes n pages PG<0> through PG<n>, each controlled by n word lines WL0 through WLn. It has been shown in the drawing that each of the planes PN<0> through PN<3> includes one page buffer. It is, however, to be understood that each plane can include as many page buffers as bit line pairs (one page buffer is connected to one bit line pair).

Referring to FIG. 4, data are loaded sequentially onto each of the page buffers PB<0> through PB<3> within each of the planes (e.g., four planes PN<0> through PN<3>). At a first time period (\textcircled{1}), first data are loaded onto the first page buffer PB<0>; at a second time period (\textcircled{2}) second data are loaded onto the second page buffer PB<1>; at a third time period (\textcircled{3}) third data are loaded onto the third page buffer PB<2>; at a fourth time period (\textcircled{4}) fourth data are loaded onto the fourth page buffer PB<3>. After the first data are loaded onto the first buffer, the first data loaded onto the first page buffer PB<0> are programmed into a corresponding page PG<0> within a selected memory block (e.g., MB<0>) within the first plane PN<0>, e.g., starting at the second time period (\textcircled{2}).

Meanwhile, if the second data have been loaded onto the second page buffer PB<1> of the second plane PN<1> during the second time period (\textcircled{2}), the second data loaded onto the second page buffer PB<1> are started being programmed (e.g., starting at the third time period (\textcircled{3})) into a corresponding page PB<0> within a selected memory block (e.g., MB<0>) within the second plane PN<1> whether or not the first data have all been programmed into the first plane PN<0>.

Also, if the third data have been loaded onto the third page buffer PB<2> of the third plane PN<2> during the third time period (\textcircled{3}), the third data are started being programmed (e.g., starting at the fourth time period (\textcircled{4})) into a corresponding page PB<0> within a selected memory block (e.g., MB<0>) within the third plane PN<2> whether or not the second data have all been programmed into the second plane PN<1>.

Similarly, if the fourth data have been loaded onto the fourth page buffer PB<3> of the fourth plane PN<3> during the fourth time period (\textcircled{4}), the fourth data are started being programmed into a corresponding page PB<0> within a selected memory block (e.g., MB<0>) within the fourth plane PN<3> whether or not the third data have all been programmed into the third plane PN<2> (\textcircled{5}).

The programming method above provides significant improvement in programming speed over conventional methods. For example, assuming that one page buffer is 2 Kbyte, the time in which data are loaded onto one page buffer is 25 ns and a program time of one page is 150 us in the NAND flash memory device having the 4-plane structure, the time in which eight pages are consecutively programmed is (50 us×8)+150 us=550 us where 50 us=2 K×25 ns.

In the conventional multi-page program method, after data that will be programmed into eight pages are sequentially input to four page buffers using the first four pages of data, then the four pages are programmed at the same time. Thereafter, after the next four pages of data are sequentially input to the four page buffers, the four pages are again programmed at the same time. In the present multi-page program method, each of the eight pages are programmed sequentially in a staggered-fashion. In other words, data are sequentially input to the page buffers of the planes. For each plane, the program operation starts once the data have been loaded onto its page buffer (see FIG. 5) without waiting for the completion of previously initiated program operations in other planes.

The program operation in each plane is carried out independently of the other planes. That is, in the present embodiment, the data loading time and the data program time are overlapped with each other as described above, which is somewhat similar to the cache program method in the related art. In the cache program method, however, the data loading time is buried in the program time. Therefore, when programming eight pages, one first data loading time and eight program times are required. In the present embodiment, when programming eight pages, eight data loading times and one data program time are required.

The present program method provides a significant improvement in speed over the conventional methods, the multi-page program method has a program time of 700 us, the cache program method has a program time of 1250 us, and the general program method has a program time of 1600 us. The program method of the present embodiment, however, requires 550 us to program eight pages.

Therefore, in accordance with the program method of the present embodiment, the program time can be significantly reduced in comparison with the program method in the related art.

It has been described above that data loading onto the page buffer within each of the planes PN<1> through PN<4> is sequentially performed. However, the data loading can be performed only in some planes. For example, in the case where four planes exist, data loading can be performed in the first, third and fourth planes and data loading can be performed only in the second and fourth planes. Accordingly, the term sequentially refers to the order of the planes that have been selected for programming, rather than actual physical arrangement. In certain applications, the physical arrangement and the order of selected planes may be the same.

In addition to being faster than the conventional cache program method, the present program method enables the use of a smaller-sized page buffer. In the conventional cache method, two latches are used in each page buffer to store data being programmed and data to be programmed next. In the present program method, however, only one latch may be used in a page buffer since data for other page buffers may be loaded while the data loaded into the given page buffer are being programmed. Therefore, latches of the other page buffers function as a kind of secondary cache buffers.

Although the foregoing description has been made with reference to the preferred embodiments, it is to be understood that changes and modifications of the present invention may be made by the ordinary skilled in the art without departing from the spirit and scope of the present invention.

What is claimed is:

1. A program method for a non-volatile memory device, the method comprising:
storing first data to a first page buffer of a first plane of the memory device;
programming the first data stored in the first page buffer to a first page of the first plane;
storing second data to a second page buffer of a second plane of the memory device while the first data are being programmed into the first page of the first plane; and
programming the second data stored in the second page buffer to a second page of the second plane while the first data are being programmed into the first page of the first plane.

2. The method of claim 1, further comprising:
storing third data to a third page buffer of a third plane of the memory device while the second data are being programmed into the second page of the second plane; and
programming the third data stored in the third page buffer to a third page of the third plane while the second data are being programmed into the second page of the second plane.

3. The method of claim 2, wherein the third data are being stored to the third page buffer while the first data are being programmed into the third page of the third plane, wherein the non-volatile memory device is a NAND flash memory device.

4. The method of claim 3, wherein the memory device includes a plurality of planes, each plane being configured to be selected for being programmed at a particular order with respect to other planes.

5. The method of claim 1, wherein the program operation includes first, second, third, and fourth periods of time, wherein the first data are stored into the first page buffer during the first period, the second data are stored into the second page buffer during the second period, wherein the first data are programmed into the first page at least during the second and third periods, wherein the second data are programmed into the second page at least during the third and fourth periods.

6. The method of claim 5, wherein a program operation involving N number of pages is completed by (N×Ts)+Tp, wherein Ts relates to a time period required to load given data to a given page buffer in a given plane, wherein Tp relates to the a time period required to program the given data loaded onto the given page buffer to a given page in the given plane.

7. A method for performing a program operation of a non-volatile memory device, the method comprising:
loading first, second, third, and fourth data to first, second, third, and fourth page buffers, respectively, in sequence;
programming the first data loaded onto the first page buffer into a first page while loading the second data to the second buffer; and
programming the second data loaded onto the second page buffer into a second page while programming the first data into the first page.

8. The method of claim 7, wherein the second data are being programmed into the second page while loading the third data onto the third page buffer.

9. The method of claim 7, wherein the first, second, third, and fourth page buffers are in first, second, third, and fourth planes, respectively.

10. The method of claim 7, wherein the memory device includes a plurality of planes, wherein at least one plane has a plurality of page buffers.

11. The method of claim 10, wherein one of the planes includes the first and third page buffers.

12. The method of claim 7, wherein the first, second, third, and fourth page buffers correspond to the order of planes selected for programming.

13. The method of claim 7, wherein the program operation includes first, second, third, fourth periods of time, wherein the first, second, third, and fourth data are loaded into the first, second, third, and fourth page buffers during the first, second, third, and fourth periods, respectively.

14. The method of claim 13, wherein the first data are programmed into the first page at least during the second and third periods, wherein the second data are programmed into the second page at least during the third and fourth periods.

15. The method of claim 7, wherein the program operation involves N number of pages and is completed by (N×Ts)+Tp, wherein Ts relates to a time period required to load given data to a given page buffer, wherein Tp relates to the a time period required to program the given data stored in the given page buffer into a given page, wherein a time period Ts of each of the first, second, third, and fourth data is substantially the same, and a time period Tp for each of the first, second, third, and fourth data is substantially the same.

16. The method of claim 7, wherein the non-volatile memory device is a NAND flash memory device.
